(19) United States
(12) Patent Application Publication
(10) Pub. No.: US 2025/0274999 A1
(43) Pub. Date: Aug. 28, 2025

(54) MASSIVELY COORDINATED ACCESS POINT (AP) SERVICE PERIODS AND SERVICE INTERVALS

(71) Applicant: Cisco Technology, Inc., San Jose, CA (US)

(72) Inventors: Brian D. Hart, Sunnyvale, CA (US); Malcolm M. Smith, Richardson, TX (US); Binita Gupta, San Diego, CA (US)

(73) Assignee: Cisco Technology, Inc., San Jose, CA (US)

(21) Appl. No.: 19/062,720

(22) Filed: Feb. 25, 2025

Related U.S. Application Data
(60) Provisional application No. 63/557,586, filed on Feb. 25, 2024.
(60) Provisional application No. 63/557,587, filed on Feb. 25, 2024.

(51) Int. Cl. H04W 76/14

(52) U.S. Cl. CPC H04W 76/14

(57) ABSTRACT

Massively coordinated Access Point (AP) service periods and service intervals may be provided. A first value may be determined comprising a number of Access Points (APs) that are seen by a first AP in a first cluster of APs. The first AP and the APs that are seen by the first AP may comprise a first group in the first cluster of APs. Next a second value may be determined comprising a next power-of-x greater than the first value. Then a number of service periods per service interval may be determined to be the second value.

### RELATED APPLICATION

Under provisions of 35 U.S.C. § 119 (e), Applicant claims the benefit of U.S. Provisional Application No. 63/557,586 filed Feb. 25, 2024, which is incorporated herein by reference. Under provisions of 35 U.S.C. § 119 (e), Applicant claims the benefit of U.S. Provisional Application No. 63/557,587 filed Feb. 25, 2024, which is incorporated herein by reference.

### TECHNICAL FIELD

The present disclosure relates generally to providing massively coordinated Access Point (AP) service periods and service intervals.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing massively coordinated Access Point (AP) service periods and service intervals;

FIG. 2 is a flow chart of a method for providing massively coordinated AP service periods and service intervals;

FIG. 3 is a block diagram of a plurality of APs;

FIG. 4 illustrates the use of free service periods;

FIG. 5 illustrates a flow;

FIG. 6 is a block diagram of a plurality of APs;

FIG. 7 is a block diagram of a plurality of APs;

FIG. 8 illustrates a flow; and

FIG. 9 is a block diagram of a computing device.

### DETAILED DESCRIPTION

### Overview

Massively coordinated Access Point (AP) service periods and service intervals may be provided. A first value may be determined comprising a number of Access Points (APs) that are seen by a first AP in a first cluster of APs. The first AP and the APs that are seen by the first AP may comprise a first group in the first cluster of APs. Next a second value may be determined comprising a next power-of-x greater than the first value. Then a number of service periods per service interval may be determined to be the second value.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

To improve reliability and Quality-of-Service, the Institute of Electrical and Electronics Engineers (IEEE) 802.11bn/Ultra High Reliability (UHR) specification may define multi-AP coordination. Some of these coordination processes may be fairly simple using agreed (and often long-lived) Time Division Multiple Access TDMA assignments. For instance one process may have an isolated island of six cochannel APs, each taking turns to have 2 msec Service Periods (SPs) and so the Service Interval (SI) is 12 msec. During an SP, one AP schedules the medium.

There may, however, be other APs nearby. Also, more APs may be near those APs and so on, until there may be a network of millions of APs (e.g., APs at 2.4 GHz in city downtowns). This may look like a spiral galaxy with a dense downtown at the center, but then sparse spiral arms radiating out (e.g., the last 100,000 APs on a spiral arm may be in the countryside with much greater than six cochannel APs in range of each other). Almost surely, coordination of such a huge network spanning “millions” of management domains must be distributed.

Given the desirability of each local area having at most one AP scheduling the medium time in the area at a time (e.g., to avoid collisions for reliability), and each local area almost always having at least one AP scheduling traffic (whenever offered) for efficiency, embodiments of the disclosure may provide the rules for a distributed process to achieve this. This distributed process may be adaptive to account for spatial variations in AP density (e.g., Manhattan to the countryside).

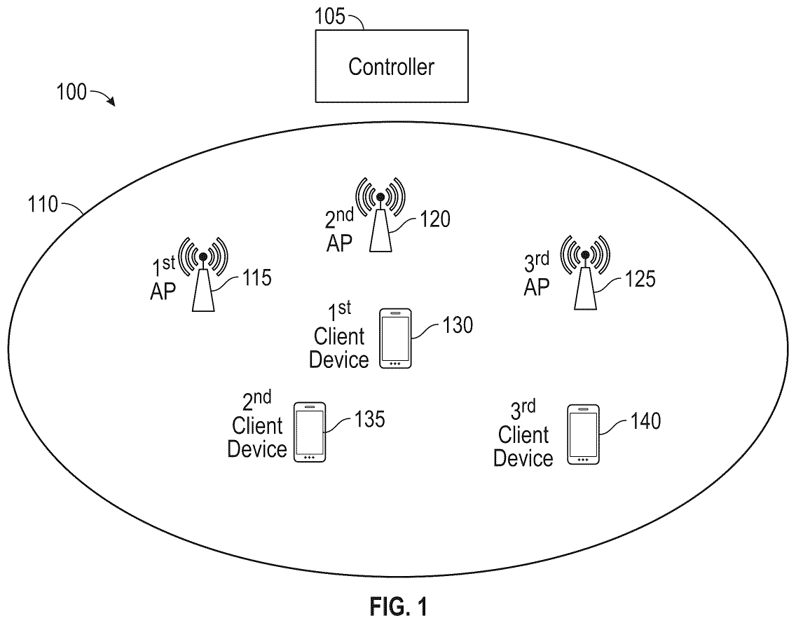

FIG. 1 shows an operating environment 100 for providing massively coordinated Access Point (AP) service periods and service intervals. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

The plurality of APs and the plurality of client devices may also have a UWB radio that may use UWB radio technology using a very low energy level for short-range, high-bandwidth communications over a large portion of the radio spectrum. UWB may transmit information across a wide bandwidth (e.g., >500 MHZ). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide massively coordinated Access Point (AP) service periods and service intervals.

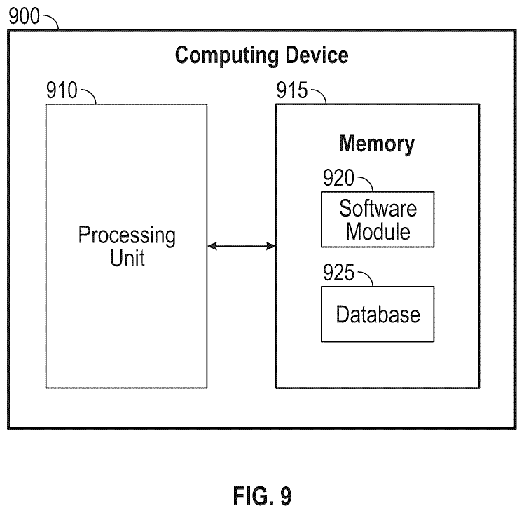

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 9, the elements of operating environment 100 may be practiced in a computing device 900.

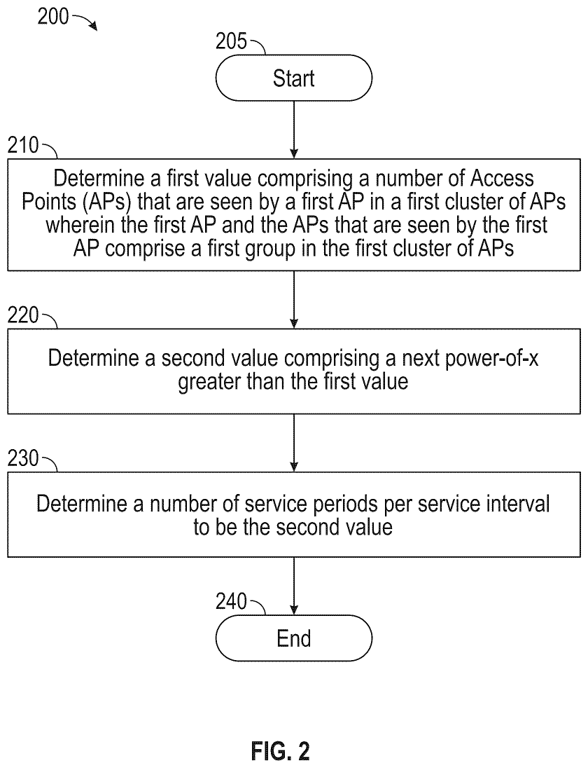

FIG. 2 is a flow chart setting forth the general stages involved in a method 200 consistent with embodiments of the disclosure for providing massively coordinated AP service periods and service intervals. Method 200 may be implemented using a computing device 900 as described in more detail below with respect to FIG. 9. Computing device 900 may be embodied by controller 105 or any of the plurality of APs described above or below. Ways to implement the stages of method 200 will be described in greater detail below.

To understand the problem in more detail, there may be areas with more or fewer cochannel APs (e.g., 20-100 in Manhattan, 1-2 in upstate NY). Between these two extremes, say there is an area with 7 fully connected APs and an adjacent area with 3 fully connected APs, and with 1 AP in common. One issue may be how to share 7 SPs across an SI (e.g., 12 msec) to sharing 3 SPs across the SI (e.g., 12 msec). Because it may be difficult to coordinate relatively prime SPs, embodiments of the disclosure may split the SI into N equal-length SPs, where N is a power-of-x, where x may comprise an integer greater than 1.

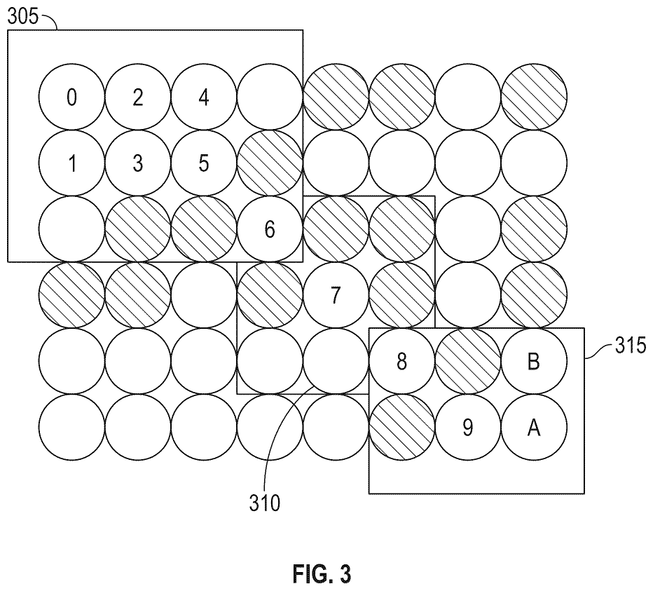

For example, FIG. 3 shows a plurality of APs comprising a first cluster 305, a second cluster 310, and a third cluster 315. AP 0, AP 1, AP 2, AP 3, AP 4, AP 5, AP 6, AP 7, AP 8, AP 9, AP A, and AP B, may be cochannel APs. The remaining ones of the plurality of APs (illustrated by hatching and by blank open circles) may not be cochannel with AP 0, AP 1, AP 2, AP 3, AP 4, AP 5, AP 6, AP 7, AP 8, AP 9, AP A, and AP B. AP 0, AP 1, AP 2, AP 3, AP 4, AP 5, AP 6 may comprise a first group in first cluster 305. AP 6, AP 7, and AP 8 may comprise a second group in second cluster 310. AP 8, AP 9, AP A, and AP B may comprise a third group in third cluster 315. In the example shown in FIG. 3, AP 7 of the second group can see AP 6 of the first group. Furthermore, AP 7 of the second group can see AP 8 of the third group.

Method 200 may begin at starting block 205 and proceed to stage 210 where computing device 900 may determine a first value comprising a number of Access Points (APs) that are seen by a first AP in a first cluster of APs wherein the first AP and the APs that are seen by the first AP may comprise a first group in the first cluster of APs. For example, the first AP may comprise AP 0 and it may see AP 1, AP 2, AP 3 comprising the first group. In this example, the number of APs seen by AP 0 may be 3.

From stage 210, where computing device 900 determines the first value comprising the number of APs that are seen by the first AP in the first cluster of APs, method 200 may advance to stage 220 where computing device 900 may determine a second value comprising a next power-of-x greater than the first value. For example, consistent with embodiments of the disclosure, x may comprise an integer greater than 1 (e.g., 2). In the above example where the first value is 3 and x is 2, next power-of-x (e.g., x=2) greater than the first value (e.g., 3) is 8.

Once computing device 900 determines the second value comprising the next power-of-x greater than the first value in stage 220, method 200 may continue to stage 230 where computing device 900 may determine a number of service periods per service interval to be the second value. For example, each AP in the plurality of APs in FIG. 3 may determine how many in-range APs it sees, and determine number of service periods per service interval equal to the next power-of-x (e.g., where x may equal 2) of that number. In the example shown in FIG. 3, some of APs 0-6 in the dense cluster at top left (i.e., first cluster 305) may see greater than 4 APs so at least one AP in this cluster may ask for the number of service periods per service interval equal to 8. All APs in first cluster 305 may be forced to accept this request of an 8 service interval. The density is a little lower around APs 6-8 (i.e., second cluster 310), but each of the APs in that cluster see AP 6, which is in a service periods per service interval equal to 8 cluster (i.e., first cluster 305), so APs 6-8 (i.e., second cluster 310) are given a service periods per service interval equal to 8 as well.

It may be seen that the power-of-x (e.g., where x may be equal to 2) may often be somewhat higher than the number of APs in a given cluster, so there may be some free service periods that may be left to Carrier Sense Multiple Access with Collision Avoidance (CSMA/CA). These free service periods may be allocated to an AP (e.g., the first AP that asks for it or is best by some measure such as an AP that holds the previous service period, up time, Media Access Control (MAC) address, Quality-of-Service (QOS) flows etc.).

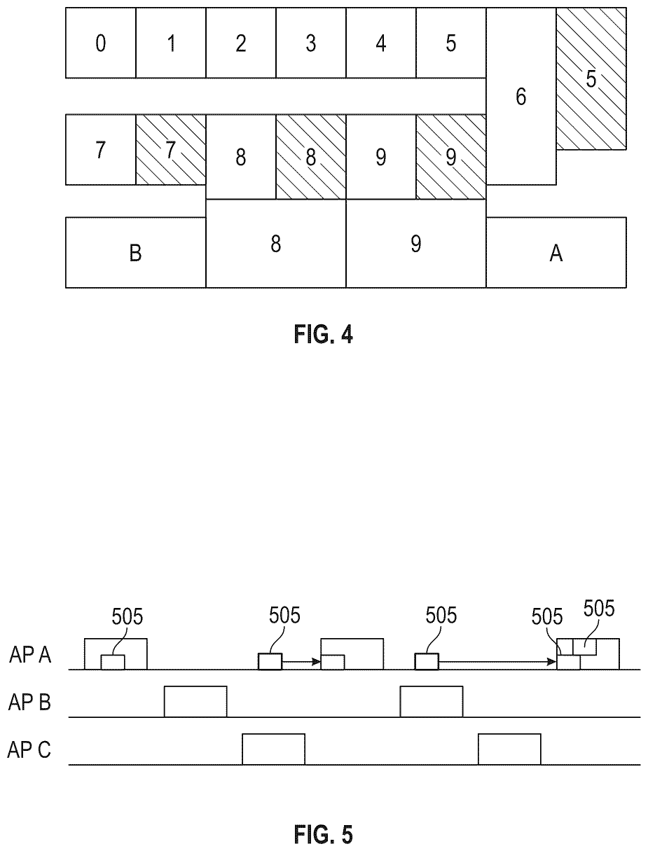

The use of free service periods may be illustrated in FIG. 4. In the first row (top) of FIG. 4, APs 0-6 (i.e., first cluster 305) agree on a service periods per service interval equal to 8 as described above. In this way, 7 out of the 8 service periods are “owed” by an AP in first cluster 305 (e.g., an algorithm may have a rule that every AP may always get at least 1 service period as illustrated by the open boxes). In the example of FIG. 4, AP 5 may happen to obtain the last free service period of the 8 as illustrated by the hatched box in the first row. In this example, AP 5 and AP 6 may impinge on AP 7, and AP 6 and AP 7 may impinge on AP 8. Accordingly, the minimum service periods per service interval may be 4, however as described above, AP 6 was given a service periods per service interval equal to 8, so APs 6-8 (i.e., second cluster 310) all have a service periods per service interval equal to 8 too. APs 6-8 are each owed service period as is illustrated as the 4 open boxes at middle row. There are free service periods adjacent to AP 7's, AP 8's, and AP 9's owned service periods, so AP 7, AP 8, and AP 9 may each obtain them on boundaries (i.e., hatched boxes in middle row). “Even” boundaries may be given priority, for example, phase 0+1 and phase 2+3, rather than phase 1+2 or phase 3+4.

AP 7, AP 8, and AP 9 may declare themselves as having 1+1 eighths of the service interval with service periods per service interval equal to 8 and at the same time declare themselves as having 1 quarter of the service interval with service periods per service interval equal to 4. In other words, AP 7, AP 8, and AP 9 may have two personas with two adjacent short service periods giving it one long overall service period. Because AP 9, AP A, and AP B may only see four APs, and none of those seen APs need more than a service periods per service interval equal to 4, then they may each choose a service period per service interval equal to 4. In this way, embodiments of the disclosure may provide a global service interval, but have defined distributed rules such that service period durations may be reasonably well optimized to the local AP density in given AP clusters.

As a variant of this embodiment, instead of APs obtaining adjacent service periods on even boundaries (phase of +−1), APs may obtain the service period at a phase offset service interval/(2*service period). Then, instead of getting say 6 msec every 12 msec, they may have 3 msec on, 3 msec off, 3 msec on, 3 msec off etc., for reduced channel access delay. Once computing device 900 determines the number of service periods per service interval to be the second value in stage 230, method 200 may then end at stage 240.

As stated above, to improve reliability and Quality-of-Service, the Institute of Electrical and Electronics Engineers (IEEE) 802.11bn/Ultra High Reliability (UHR) specification may define multi-AP coordination. Some of these coordination processes may be fairly simple using agreed (and often long-lived) Time Division Multiple Access TDMA assignments. For instance, one process may have an isolated island of six co-channel APs, each taking turns to have a 2 msec Service Periods (SPs) and so the Service Interval (SI) is 12 msec. During an SP, one AP schedules the medium.

More generally, APs may control client transmissions using triggered access (e.g., Multi-user Enhanced Distributed Channel Access (MU-EDCA) parameters). This may make possible an AP-to-AP scheduling layer that may be independent of client flows. These AP-to-AP scheduling layers may assign SPs to different APs so that: i) each AP gets a regular SP; ii) each local area may have at most one AP scheduling the medium time in the area at a time (i.e., to avoid collisions for reliability); and iii) each local area may almost always have at least one AP scheduling traffic (whenever offered) for efficiency. However, different flows may have different requirements on service interval (e.g., every 20 msec/50 Hz or codecs that operate any of 60/72/80/90 Hz, or beacons every 102.9 msec. Thus, beyond trivial cases, the AP service interval and the flow service interval may almost always be mismatched. Then a flow 505 in FIG. 5 may have to wait perhaps adding intolerable latency.

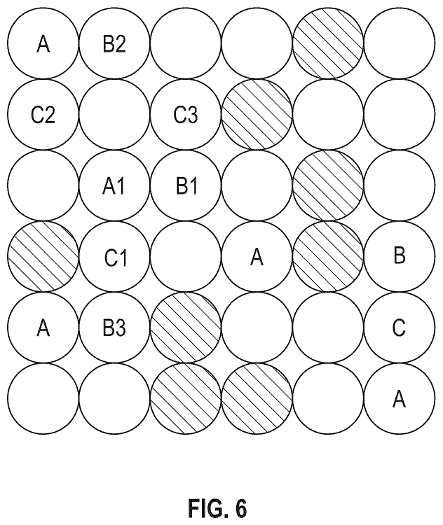

FIG. 6 illustrates a plurality of APs. The labeled APs may comprise a Basic Service Sets (BSSs) on one channel, the hatched APs may comprise BSSs on another channel, and the open or blank APs may comprise more channels. AP A and AP A1 may transmit at the same time as AP A. AP B, AP B1, AP B2, and AP B3 may transmit at the same time as AP B. AP C, AP C1, AP C2, and AP C3 transmit at the same time as AP C. Interference range may comprise 2.5 diameters for example.

If AP1 has a flow that needs channel access during the B phase (i.e., the service periods owned by AP B, or more generally, owned by AP B1, AP B2, and AP B3), then it cannot just ask for AP B1 to carve out some time from AP B1's service period because it may still suffer from interference from AP B2 and AP B3 (and their BSSs). According, embodiments of the disclosure may deal with multiple nearby APs. For example, embodiments of the disclosure may use multi-grantor Coordinated Time-division Multiple Access (C-TDMA) that may enable one AP to request time from its cochannel neighboring APs even in the middle of the neighboring APs' own service periods.

In terms of the earlier example of FIG. 5, an AP needing medium time for its time-critical flows during another phase sends requests to nearby APs of that phase indicating the one-off or sequence of SPs for which the AP needs medium time. For example, the request may be sent out of band/wirelessly during its own phase when the medium is determined to be idle and Request to Send (RTS) and Clear to Send (CTS) works with the peer AP.

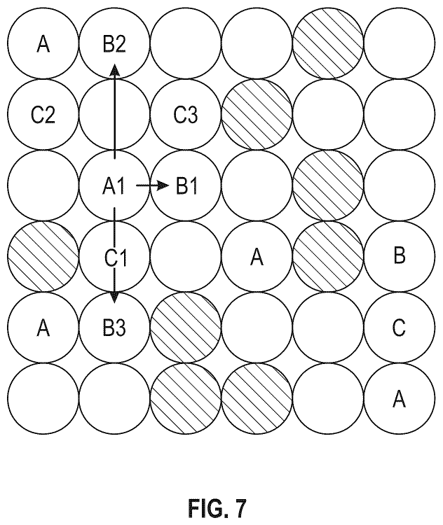

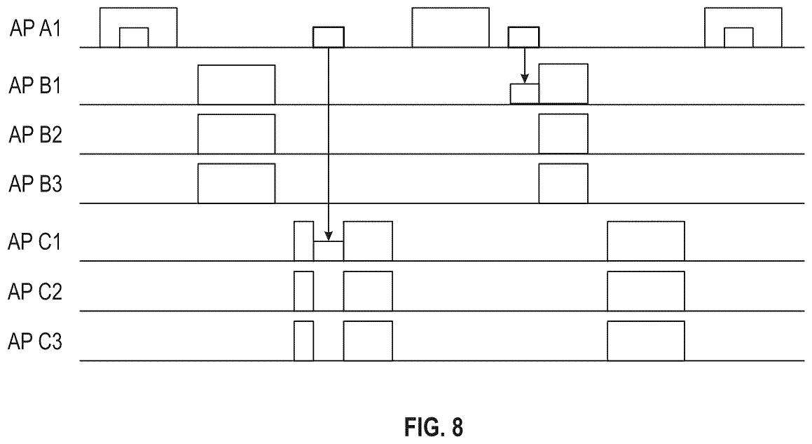

As shown in FIG. 7, AP A1 may message AP B1, AP B2, and AP B3 describing its needs. This could be via sharing Stream Classification Service (SCS) (e.g., QoS Characteristics) including min SI=max SI. Traffic Identifier (TID), delay bound, or other priority measure may be included. If any APs are managed by a WLC or similar, the messages may go to/from the WLC on behalf of the AP and reduce network delays and traffic whenever two APs are both managed by the same WLC. If the carve-out of the neighboring APs is accepted, an example of the time behavior of the system may be illustrated by FIG. 8.

The AP to AP control to provide for multi-grantor C-TDMA can be one or more of the following. The neighboring APs may split their service period into two, with Transmission Opportunities (TXOPs) ending just before the requested carve out, and then TXOP(s) resuming at the end of the requested carve-out. The TXOPs after the carve-out may begin at a scheduled time or immediately after AP A1 indicates it is done (e.g., via Control Frame (CF)-End or an AP-AP “done” message that may not affect the Network Allocation Vector (NAV) of other clients).

The control may also include, at an agreed time, one elected neighboring AP may transmit a frame such as an AP-AP trigger frame to grant medium to AP A1 for its flow and the others ensure their first TXOP(s) are ended. The control may also include that the neighboring APs record the timing and frequency offset of the most recent transmission by AP A1, then, at the agreed time and with frequency pre-compensation, “simulcast” an identical frame in a Physical layer Protocol Data Unit (PPDU) such as an AP-AP Trigger frame to grant medium to AP A1 for its flow.

The control may also include, at approximately the agreed time (e.g., within a few microseconds), all neighboring APs may transmit an identical frame such as an AP-AP trigger frame to grant medium to AP A1 for its flow. Because the PPDU containing the frame may not be well-controlled in terms of start time and frequency offset, it may not be guaranteed receivable by AP A1, though one copy may be, for example, if that AP was just a lot stronger than the others at AP A1. Still, AP A1 may know that this is when it was allocated time, and may begin transmission immediately (e.g., + Short Interframe Space (SIFS)) after that PPDU.

Accordingly, embodiments of the disclosure may provide lowest latency for flows while preserving determinism (i.e., collision free control) in a dense TDMA system wherein each AP has a service period at one phase of a service interval, an AP with a flow that merits service outside the AP's service period (phase) may report this need to the neighboring APs on that phase. These neighboring APs may get out of the way of that AP's flow via a multi-AP grant of a portion of their service period.

FIG. 9 shows computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for providing massively coordinated AP service periods and service intervals as described above with respect to FIG. 2. Computing device 900, for example, may provide an operating environment for controller 105, first AP 115, second AP 120, third AP 125, first client device 130, second client device 135, or third client device 190. Controller 105, first AP 115, second AP 120, third AP 125, first client device 130, second client device 135, or third client device 190 may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 900 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining, by a computing device, a first value comprising a number of Access Points (APs) that are seen by a first AP in a first cluster of APs wherein the first AP and the APs that are seen by the first AP comprise a first group in the first cluster of APs;
determining a second value comprising a next power-of-x greater than the first value; and
determining a number of service periods per service interval to be the second value.

2. The method of claim 1, further comprising assigning the number of service periods per service interval to the first AP.

3. The method of claim 1, further comprising assigning the number of service periods per service interval to the first group in the first cluster of APs.

4. The method of claim 1, further comprising allocating a free service period in the number of service periods to a receiving AP in the first group.

5. The method of claim 4, wherein allocating the free service period comprises allocating the free service period based on a request from the receiving AP.

6. The method of claim 4, wherein allocating the free service period comprises allocating the free service period based on the receiving AP having a previous adjacent service period.

7. The method of claim 1, wherein x equals 2.

8. The method of claim 1, wherein x equals 3.

9. The method of claim 1, wherein x equals an integer greater than 1.

10. The method of claim 1, wherein computing device comprises the first AP.

11. A system comprising:
a memory storage; and
a processing unit coupled to the memory storage, wherein the processing unit is operative to:
determine a first value comprising a number of Access Points (APs) that are seen by a first AP in a first cluster of APs wherein the first AP and the APs that are seen by the first AP comprise a first group in the first cluster of APs;
determine a second value comprising a next power-of-x greater than the first value; and
determine a number of service periods per service interval to be the second value.

12. The system of claim 11, wherein the processing unit is further operative to assign the number of service periods per service interval to the first AP.

13. The system of claim 11, wherein the processing unit is further operative to assign the number of service periods per service interval to the first group in the first cluster of APs.

14. The system of claim 11, wherein the processing unit is further operative to allocate a free service period in the number of service periods to a receiving AP in the first group.

15. The system of claim 14, wherein the processing unit being further operative to allocate the free service period comprises the processing unit being further operative to allocate the free service period based on a request from the receiving AP.

16. The system of claim 14, wherein the processing unit being further operative to allocate the free service period comprises the processing unit being further operative to allocate the free service period based on the receiving AP having a previous adjacent service period.

17. A non-transitory computer-readable medium that stores a set of instructions which when executed perform a method executed by the set of instructions comprising:
determining, by a computing device, a first value comprising a number of Access Points (APs) that are seen by a first AP in a first cluster of APs wherein the first AP and the APs that are seen by the first AP comprise a first group in the first cluster of APs;
determining a second value comprising a next power-of-x greater than the first value; and
determining a number of service periods per service interval to be the second value.

18. The non-transitory computer-readable medium of claim 17, wherein x equals 2.

19. The non-transitory computer-readable medium of claim 17, wherein x equals 3.

20. The non-transitory computer-readable medium of claim 17, wherein x equals an integer greater than 1.
